(19) United States
(12) Patent Application Publication
(10) Pub. No.: US 2008/0248874 A1
(43) Pub. Date: Oct. 9, 2008

(54) Apparatus for Decreasing the Circulation of Money of Small Denominations, Arrangement and Method for Drawing Lots

(75) Inventors: Tamas Pajor, Budapest (HU); Robert Kassai, Budapest (HU); Gabor Kovacs, Budapest (HU); Andras Sugar, Budapest (HU)

Correspondence Address: YOUNG & THOMPSON, 209 Madison Street, Suite 500, ALEXANDRIA, VA, 22314, US

(73) Assignee: Tamas Pajor, Budapest (HU)

(21) Appl. No.: 11/579,160

(22) PCT Filed: May 3, 2005
(86) PCT No.: PCT/HU2006/000045

§ 371 Date: Oct. 31, 2006

(30) Foreign Application Priority Data
May 3, 2004 (HU) P0400907
Dec. 18, 2004 (HU) P0402637

(51) Int. Cl. A63F 9/24; G06Q 20/00

(52) U.S. Cl. 463/42; 705/16; 705/17; 705/24

(57) ABSTRACT

Apparatus for decreasing the circulation of money of small denominations and coins, includes a first input unit for inputting the amount to be paid, connected to a central unit, a second input unit for inputting a rounded amount to be paid connected to the central unit and controlling a rounding unit, a display unit showing a rounded payable sum defined by the rounding unit and a printing unit connected to the central unit. A method and arrangement for drawing lots include an input unit for entering data of participation in the drawing, and a drawing centre including a database of game rules, a game rule interpreting unit, an odds creating unit and a drawing unit connected to a prize indicating unit. The input unit is connected to the drawing centre via a control unit; a game database is connected to the control unit.

The invention relates to an apparatus for decreasing the circulation of notes of small denomination and coins, especially for use at retail sales points by means of producing a product having a price that rounds up the amount to be paid.

Furthermore, the invention relates to an arrangement for drawing lots, which arrangement consists of an input unit, drawing unit, and a prize displaying unit.

Furthermore, the invention relates also a method, in the course of which a wagerer wishing to participate in a draw plays a stake at the draw, the stake is accepted, booked down, if necessary, and a receipt is given thereof, then performing the draw based on the stake and according to prescribed drawing rules, and in case of winning, the prize won is paid out to the wagerer.

In practice it occurs that customers do not want to have the change returned, and leave the amount to be returned at the cashier as a present. In other cases they insert the returned coins or banknotes of small denomination into a box for the collection of donations meant for charity or other purposes. Some merchants give sweets or other objects in exchange for tile change to be returned. No apparatus or arrangement serving a similar purpose is known.

Arrangements configured for drawing lots are known from the state of the art, and their most typical examples are the so-called gambling machines. For instance, in case of a roulette machine the player plays his/her stake by inserting cash, then starts the roulette machine, which performs the draw according to the prescribed rules, and if the wagerer played a stake which results in a prize according to the prescribed game rules, the roulette machine hands out the prize determined according to the rules in the form of cash. For carrying out all these operations the roulette machine has a drawing centre, a data input unit for the purpose of inputting the stake wanted to be played, a lot/prize drawing unit, a game rule database comprising the rules of the roulette game, a unit interpreting the rules and applying them for the stake just played, and a prize displaying unit.

In case of such gambling machines neither giving a receipt of the stake played nor booking of the prize is needed. In other cases, for example in case of lottery, the wagerer plays his/her stake at the betting-shop, determines the numbers he/she wishes to play in the lottery, and gets a receipt thereof. The draw is performed according to the prescribed rules after the collection of all stakes, and if the wagerer has played numbers entitling him/her for a prize according to the prize draw and the rules, and he/she proves this fact when claiming the prize using the receipt he/she was given previously, and the organizer of the lottery pays him the prize on the basis of this receipt.

Another known type of drawing lots is drawing tickets where a wagerer buys a lottery ticket provided with an identification mark, and in the course of the draw it is determined which tickets win, and in certain cases even the amount of the prize is determined in the course of the draw.

In case of all these kinds of drawings, the wagerer has to take a separate action to participate in the draw (buying, paying for a ticket, keeping the receipt, etc.). It would be desirable to develop a kind of drawing that does not require any special measures to be taken by the wagerer, who can obtain a right to participate in the draw during his usual purchasing activity, for instance in compensation of the amount to be returned.

The aim of the invention is to develop a solution that gives opportunity for decreasing the circulation of cash, especially change by providing a solution, wherein paying at the cashier's desk enables billing of items or articles of variable price and/or quantity that supplement the payable price of the other goods to a wanted and/or previously determined round-figure price, and thus the customer shall pay this round-figure amount. As a result, the cashier does not have to return any change, or only from a round-figure amount, in certain cases has to return a round-figure amount without the use of coins, or money of small denomination.

In order to achieve the aim set an apparatus was developed that is suitable for decreasing the circulation of money of small denominations in accordance with the above aims.

Another aim of the invention is to provide an arrangement for drawing lots that comprises an input unit, a drawing unit and a prize displaying unit as usual. The input unit is located at the cashier's desk of a commercial unit, and is connected to a drawing centre through the cash register. The drawing centre has an output providing the result of the draw, which output is connected to said prize displaying unit. The prize displaying unit is located expediently in the vicinity of the cash register. This can be supplemented with a central prize displaying unit that can provide information on the prize in a form audible in a wide area or in a textual form.

Primarily, this arrangement operates as a gambling machine, and the following procedure has to be performed for the execution of the draw.

The customer arriving to the cashier's desk is a potential wagerer at the same time. When he/she pays for the goods purchased at the commercial unit, it is highly probable that this amount is not a round figure. In such case his/her attention can be drawn, for example automatically by means of the prize displaying unit, to the fact, that by rounding up the amount to be paid he/she can participate in a draw by odds proportionate to the rounding amount. In case of a positive answer either the cashier inputs the appropriate command into the cash register (e.g. inputs the rounding amount by means of the cash register), or the customer inputs the stake he wishes to play by means of the appropriate controls located at the prize displaying unit. If necessary, the cash register, along with printing the issued invoice or bill, may print a receipt of the amount of the stake, —and if there are more than one, —the type of the game chosen, the winning odds, time, and other data suitable for identification or other purposes. The cash register forwards the data of the stake and type of game input via a suitable data transmission line to the drawing centre. In the drawing centre the winning odds are determined based on these data and based on the game rules relating to the game chosen, then the draw is performed, and the customer is informed on the result of the draw by means of the prize displaying unit.

In certain cases the cash register can be used as a prize displaying unit, which issues an appropriate document indicating the prize, and the cashier can pay out the prize to the customer immediately.

For carrying out said rounding, the arrangement of the present invention expediently comprises a rounding unit, which is directly or indirectly connected to the cash register and performs the rounding of the amount shown by the cash register. The rounding unit can be located in the cash register itself, or it can be connected to the cash register indirectly, for example through a local server.

In case of another embodiment of the arrangement according to the invention, the draw does not take place immediately after defining the stake and paying the money played but later. In such a case usually a receipt must be handed out indicating the stake and type of game the wagerer played. Of course it is possible to divide the draw into two parts by prescribing an appropriate rule, where one part of the draw, the so-called primary draw is performed immediately after defining and paying the stake, then the secondary draw is performed at a later time as determined by the game rules, for example monthly or yearly. In this case the issued receipt may serve to prove that the wagerer is entitled to participate in this secondary draw. The game rule may allow the wagerer to participate only in the secondary draw. For the realization of the secondary draw the arrangement comprises a draw database, which is connected to cash registers either directly or for example through a computer serving several cash registers, i.e. through a local server for instance. In this case also the drawing unit is connected to this local server. Expediently, the draw database includes the game rules, i.e. the algorithms and the parameters to be applied to the draw.

The arrangement according to the invention may be connected to a similar arrangement by means of a central server, where the draw database of the secondary draw is connected to this central server.

In case of several arrangements a further version of the draw can be realized, where the secondary draw is performed on the basis of the stakes of the wagers stored on a local server, played in only one store for example, while the central server performs the draw based on the stakes collected from all of the local server it serves, for example from the stakes played in all stores of a chain. It is possible especially in this case that the prize display shall publish e.g. in text form in all stores if somebody has won a substantial prize in another store.

In case of a further version of the arrangement according to the invention, a card reader may be connected to the cash register (to one or several cash registers within one store). The card reader may be suitable for reading a card including a magnetic stripe device or a semiconductor device (smart card or chip card), and optionally for writing data on the card and/or modifying data on the card, if the type of the card used allows it. The card may constitute the part of the arrangement according to the invention, which part is portable by the wagerer, and may be suitable for substituting the receipt proving the played stake. Considering the fact that some kinds of such data carrier cards are generally easily counterfeited, it is worth to record the data of the card in the draw database at first, then it is useful to take additional measures to the card for the detection and/or prevention of counterfeiting. According to another possibility, the card is used only to identify a wagerer and/or to facilitate data entry, but does not substitute for the receipt.

In another embodiment of the arrangement according to the invention an input device operated by the wagerer is connected either to the cash register or to the local server through the cash register, or directly to the local server. This input device may be preferably combined with a printer and/or a prize displaying unit. The prize displaying unit may be preferably adapted to display the amount of the stake entered by the wagerer. The printing unit can be suitable for issuing the receipt identifying the stake played. It may be adapted to record the data of the stake for example, also in a bar-code form and in such case the data of the wager may be input by means of a traditional bar-code reading device used at cash registers. As a result of this structure the wagerer inputs his/her stake himself/herself, and after paying the result of the draw can be seen on the same displaying unit, as a prize displaying unit. According to a practical and possible structure of the rounding unit, it is connected to the input unit.

The data entry is facilitated if a card provided with an appropriate bar code is used along with the arrangement according to the invention, which card can be taken from a storing unit placed before the cash register for instance. The bar code may substantially determine the type of game in which the wagerer wishes to participate, and he may indicate the stake he/she wishes to play and/or a sub-variation of the game on this card.

Especially in cases when the customer wishes to pay by a certain type of bank card, rounding-up the purchase amount is not really essential. In this case a printed card may be used that basically represents a fixed-price lottery ticket, which can be considered as an item of goods. Of course, in these cases a chance for the multiplication of the stake may be given on the card with a bar-code, for example by an appropriate mark, or breaking off a part of the card, etc.

The arrangement according to the invention may preferably be used together with a conventional cash register system used in stores. It gives opportunity to connect it with the customer database of the store without infringing possible personal rights or legal regulations. Stores give different presents to their customers to increase their commercial turnover. Such present can be some kind of chance to win. One of the known solutions is to organize a draw for the customers, for example monthly, and one customer may win back the value of his purchase. This may be supplemented by a draw where pieces of goods can be won. Compared to this traditional solution, the arrangement according to the invention makes possible to carry out drawing pieces of goods simultaneously with the primary draw. In this case the customer's data need not be stored, the customer does not have to keep the receipt, but can immediately receive his/her prize, which may be e.g. winning back the whole or a part of the purchase price. The same arrangement is suitable for performing a similar secondary draw of pieces of goods simultaneously with the secondary draw, but in this case recording of certain data becomes necessary. If the customer wishes to remain anonymous, the purchase receipt or the receipt of the stake played at the draw may be suitable for proving that he/she is entitled to participate in the secondary draw of pieces of goods or other presents. Based on a similar consideration, a third level draw of presents is realizable.

Stores seek to widen the range of their customers and motivate the customers to purchase again. To this end they use different commercial methods to motivate their customers to repeated and regular purchase, and they try to establish a circle of regular customers. They award their regular customers for their “loyalty”, and customers are willing to have themselves registered into such circle of regular customers in hope of such an award, and provide the store with their data. Such regular customers' data are entered into the customer database of the store, and expediently in this database data of purchasing habits of individual customers are also collected. In certain cases a separate draw of presents are held for regular customers. The arrangement according to the invention makes it possible to carry out the drawing of lots and presents by means of the same system. In certain cases, for example due to legal restrictions, the draw database should not be connected with the customer database. In such cases these databases have to be realized separately. If no such restrictions apply (for instance the customer gives his/her consent, or no regulation prohibits the connecting together or unifying of such databases), the customer database and the draw database can be a common database. It also can be realized that the store gives a right to participate in the prize draw as a present. This present may be greater for regular customers for instance, but it is also possible that the store increases, for example doubles the stake if played by a regular customer. The arrangement according to the invention also makes it possible that the store gives a present to the regular customers that increases the customer's winning chances and/or the value of his prize in the secondary and/or third draw. It is also possible that not the store, but the manufacturer of a product gives a present to those who buy one or more of the products it manufactures. Relevant data, commands may be entered into the database including the product.

By means of the arrangement according to the invention the rounding down of the purchase price can be realized, when the prize is the extent of rounding down.

One of the advantages of that embodiment of the solution according to the invention where it is combined with rounding is in that it decreases the circulation of money bound with costs.

The invention will be explained below with reference to the exemplary embodiments shown on the attached drawings. In the drawings:

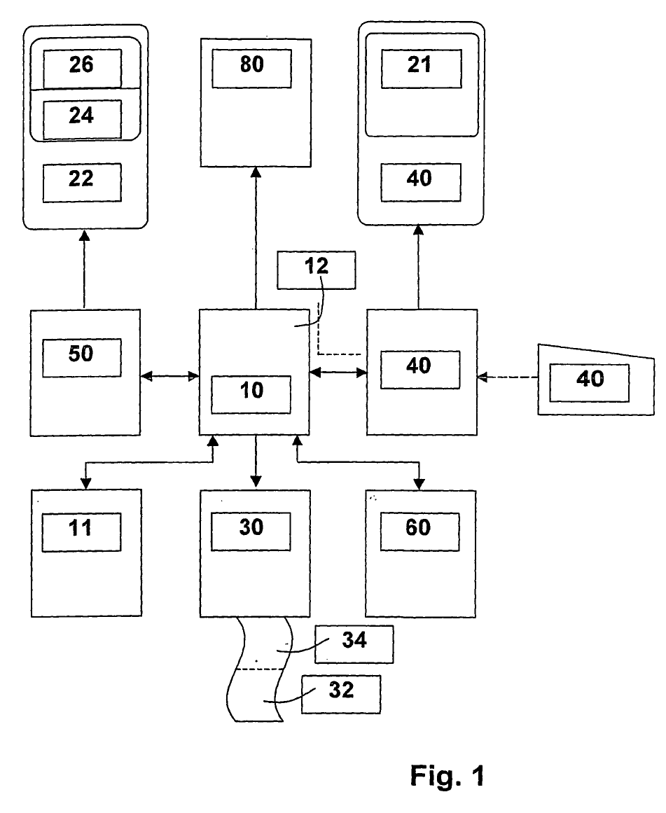

FIG. 1 shows the block diagram of the apparatus according to the invention,

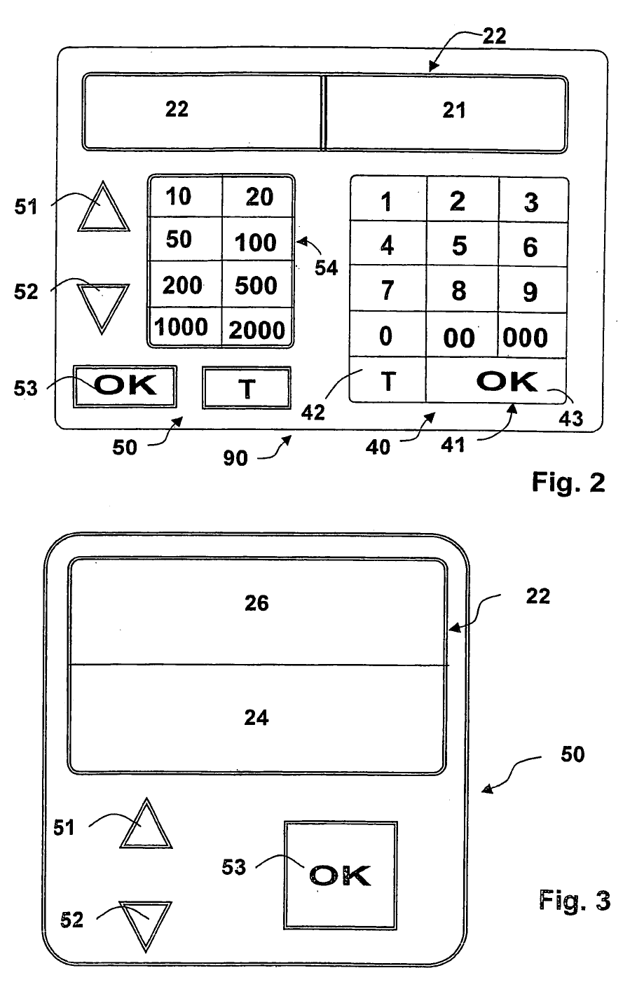

FIG. 2 shows the schematic structure of the embodiment of the combined input unit of the apparatus according to the invention designed for the common use both by the cashier and the customer,

FIG. 3 shows the schematic drawing of the embodiment of the input unit of the apparatus according to the invention designed for use exclusively by customers,

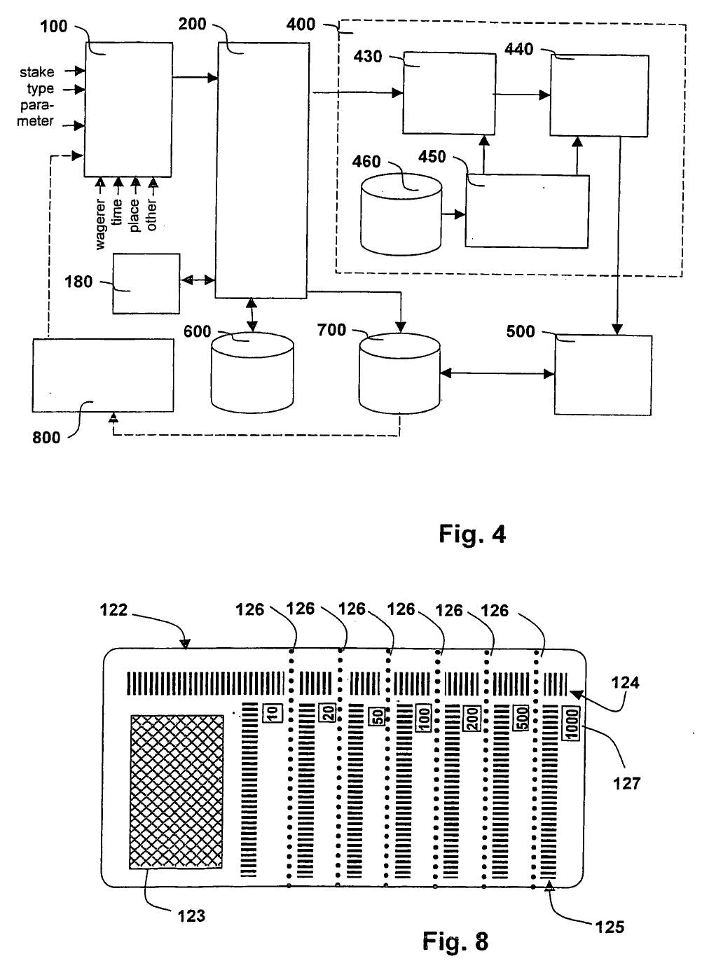

FIG. 4 is the general schematic drawing of the arrangement according to the invention,

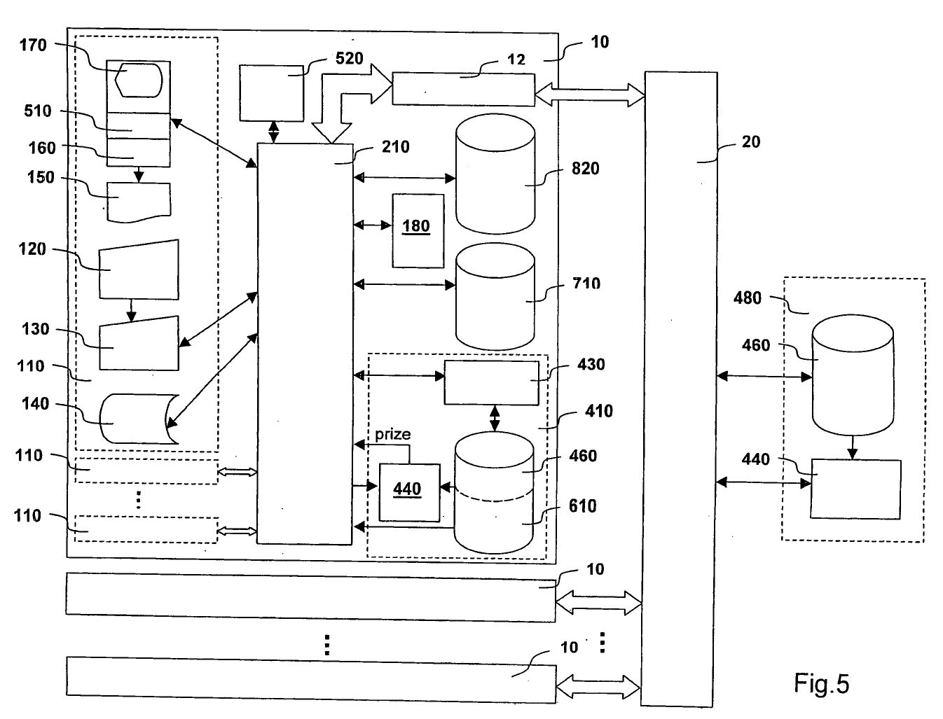

FIG. 5 is the general schematic drawing of the multi-level arrangement built of the arrangements of FIG. 4, suitable for performing multiple draws,

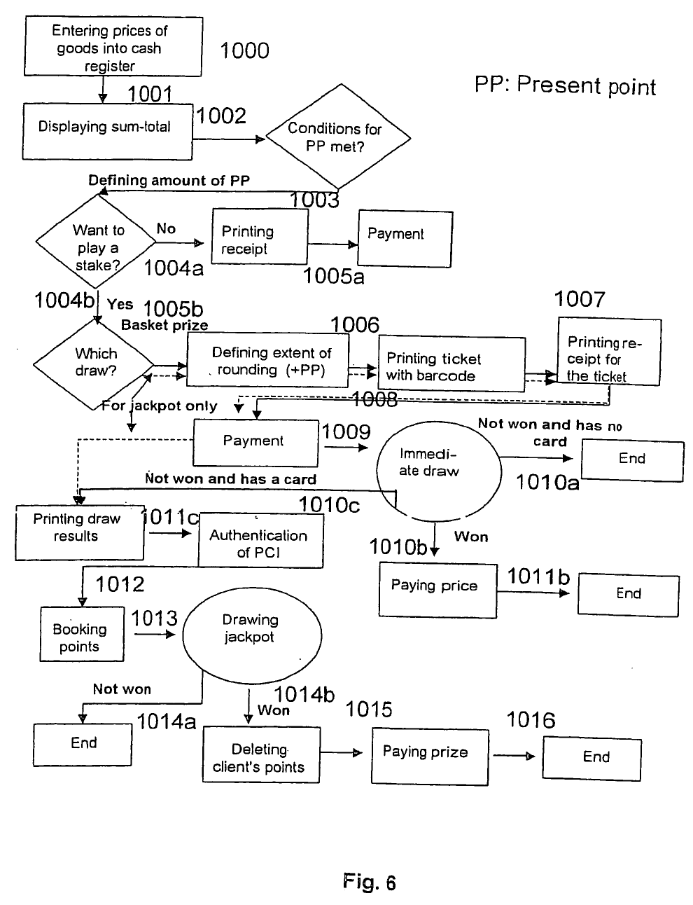

FIG. 6 is a simplified flow-chart showing the operation of the arrangement of FIG. 5 according to complicated game rules,

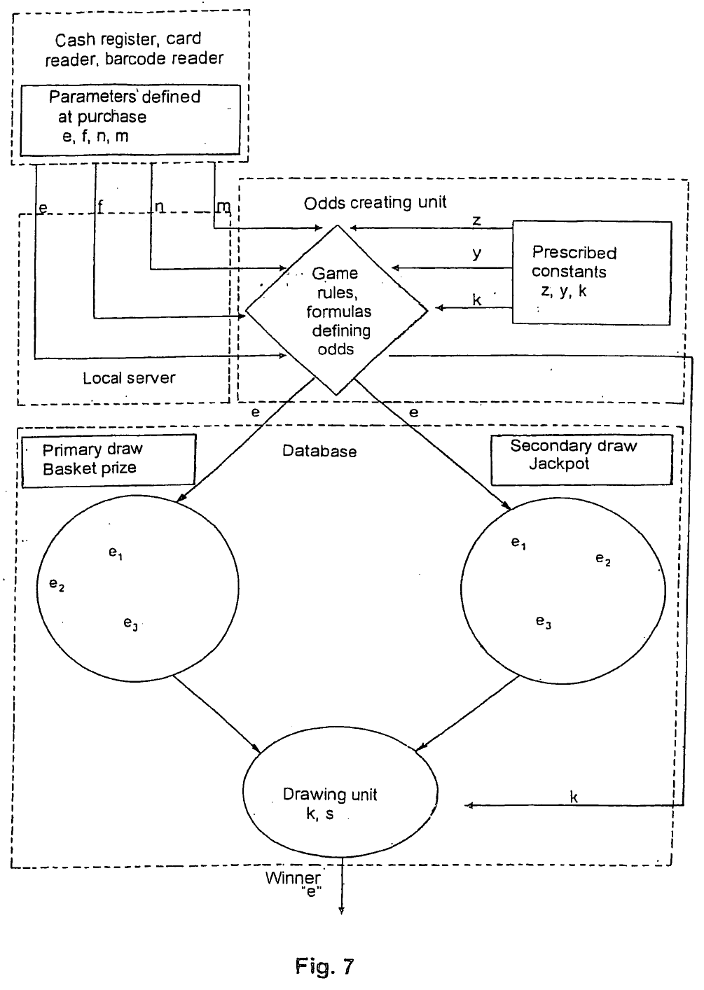

FIG. 7 is a flow-chart illustrating the operation of the arrangement of FIG. 4.

According to the block diagram shown in FIG. 1, the apparatus according to the invention comprises central unit 10 located at, or in the vicinity of a cash register 70, which central unit 10 is connected to a rounding unit 11, but of course the rounding unit 11 can form part of the central unit 10 itself, and may consist of a controller realized as an integrated circuit for instance. Furthermore, at least one input unit 40 is connected to the central unit 10. Such version may be applied if both the customer and the cashier can access the input unit 40 easily. If that is not the case, then an input unit 50 is connected to the central unit 10, which is accessible for the customers. Input units 40 and 50 are mounted with displays 21 and 22, which provide information to the customer and/or the cashier as necessary. Furthermore, to the central unit 10 a printing unit 30 is connected for printing the put-in data. As for its design, the printing unit 30 prints the data onto a paper strip, and is shaped similarly as a printing unit of cash registers, moreover, the tape printer used conventionally for the cash register 70 may be used to this end if necessary, and to this end an appropriate connection needs to be established between the apparatus according to the invention and the printer of the cash register 70.

In order to the customers being interested in decreasing the circulation of money, or for some other purpose to the central unit 10 a drawing unit 60 can be connected by means of which an immediate drawing can be realized right at the cashier's desk and immediately after payment.

In case of the apparatus according to FIG. 1 a separate input unit 50 for the customer and an other input unit 40 adapted specially for the cashier was used with the advantage that customers can overview the operation of the apparatus and see only the information being of importance to them.

FIG. 2 shows a possible embodiment of a combined input unit 90 comprising the input unit 40 adapted for the cashier and integrated with the customers' input unit 50. A keypad 41 for entering numbers is located on the input unit 40, which keypad 41 is associated with a delete button 42 and confirming or OK button 43. To the input unit 40 a display 20 is connected, which is expediently integrated into it. The display 21 is actually in connection with the central unit 10, and can be directly connected to the central unit 10. In the practice the central unit 10 can be located for example jointly with the rounding unit 11, the drawing unit 60, input unit 40 and the displaying unit 20 in a single casing, which is arranged in a manner visible and accessible both to the cashier and the customer, for instance. If such arrangement is not possible the input unit 50 adapted for the customers and the display 22 belonging to it can be located e.g. even on the other side of the same casing facing the customer, along with a keypad 41 formed as wanted.

FIG. 3 gives an example for this arrangement, where a rounding button 51, a correcting button 52, and an OK button 53 are placed on the input unit 50, respectively. In addition to these buttons and/or instead of rounding button 51 a row of buttons 54 according to FIG. 2 may be formed, on which the maximum amount of rounding, or the extent of rounding can be determined in another way. According to an additional possible version a keypad for inputting numbers, not shown but realized in the same form as keypad 41, may be arranged also on the input unit 50, and using said keypad the amount the customer wishes to pay can be input, which amount is naturally higher than the amount originally payable. A local and/or central prize indicator 80 shown on FIG. 1 is connected to the central unit 10, said prize indicator 80 indicates by sound, light or any other way that the customer has won some prize. If needed, the value and location of the prize won is announced by the loudspeaker of a greater store.

The apparatus according to the invention operates in the following way:

The cashier reads the price of individual products by eye or a code reader and inputs it into the cash register 70, and after inputting and adding up the prices of all the products calculates the amount to be paid, then opens the opportunity for rounding up the amount to be paid, for which purpose the cashier inputs the amount to be paid by means of the keypad 41. Instead of this, by using appropriate means, it may be realized that the cash register 70 connected to the apparatus according to the invention automatically forwards the amount to be paid to the apparatus according to the invention. For this purpose known, here not specified devices, e.g. wired or wireless data transmission channel, in certain cases infrared or radio-frequency data transmission device can be used, which together with the appropriate interfaces practically constitute the input unit for entering the amount to be paid. The cash register 70 itself can constitute the input unit 40 adapted for inputting the amount to be paid. The amount input or displayed appears on the displaying unit 20 visible also for the customer, which displaying unit 20 is divided to e.g. a lower part 24 and an upper part 26. The amount to be paid may be displayed on the upper part 26, and the amount rounded up and wished to be paid on the lower part 24. The amount rounded up and wished to be paid may be input both by the customer and the cashier, if necessary. The act of entering the amount may be effected e.g. by means of the rounding button 51 shown on FIGS. 2 and 3 according to the following schedule:

| | | | | |
|---|---|---|---|---|
| Amount to be paid: | HUF | 1,756 | EUR | 34.72 |
| 1^{st} button push | HUF | 1,760 | EUR | 34.80 |
| 2^{nd} button push | HUF | 1,800 | EUR | 35.00 |
| 3^{rd} button push | HUF | 2,000 | EUR | 40.00 |

When the customer reaches the amount he/she wished to be paid by the single or multiple push of the rounding button 51, he/she pushes the OK button 43. If he/she considers the amount to be paid too high, he/she decreases the amount in similar or other e.g. in smaller steps to the wanted number by pushing the correcting button 52 and finalizes this amount by pushing the OK button 53. Then the printing unit 30 prints a first ticket or coupon 32 symbolizing a product, which is added to the purchased goods having torn off by the cashier, e.g. by placing the bar code printed on it by the printing unit 30 in front of the bar code reader of the cash register 70, and the cashier returns the amount of change to the customer from the amount given him/her by the customer. The printed coupon 32 may be a purchase coupon, an amount of money that can be used in gambling machines, transport coupon, or any other tradeable product representing a value, e.g. a lottery ticket. The coupon 32 itself can be a lottery ticket, or may be exchanged to a lottery ticket or any other ticket of purchase along with other similar coupons e.g. at the customer service. The apparatus according to the invention itself may perform the draw, and if necessary, for this purpose a drawing unit 60 is connected to the central unit 10. In this case the central unit 10 calculates the value of the prize and/or the winning odds on the basis of the value of the rounding amount, and based on appropriate program performs the draw with the aid of a random number generator. The progress of the draw may be immediately displayed by means of the displaying unit 20. If needed, when calculating the winning odds or the value of the prize the amount spent on purchase can be taken into consideration also, and e.g. the value of the prize may be determined in relation to the value of purchase, for instance it can be an equal amount, or its half, quarter, etc. When calculating the winning odds, the rounding amount may be taken into account, i.e. the amount in paid in addition to the amount of purchase to be paid by the customer. Numerous algorithms are known by persons skilled in the art for determining winning odds and the value of prizes.

Such a possibility is e.g. the length of time the customer spends on the rounding, which affects the length of the total time spent by the cashier's desk. Making a quick decision may be encouraged by making the winning odds time-dependant and a timing unit 12 may placed in the central unit 10 can be used for such purpose. The display unit 22 may even indicate as the winning odds continuously decrease as the time shown by timing unit 12 passes.

The amount to be paid for the goods, the rounding amount, the parameters of the draw, and any other wanted or useful data may be stored in a data storing device of the central unit 10 not specifically shown, said device readable by means of an appropriate device from time to time, but may be stored directly or indirectly in another data storing device, e.g. the data storing device of the central computer network of the store. These data may be processed as wanted, may be added to other data, e.g. of a regular customer database.

After the draw the printing unit 30 prints out a further coupon 34, where it can be indicated how much the customer has won or that he/she did not win. If he/she has won, the cashier can immediately issue an invoice for a refund, e.g. based on the bar code printed onto the coupon, and the amount of which he/she returns to the customer at the spot, and keeps the coupon 34 for certification purposes. According to another possibility, the second coupon 34 printed by the printing unit 30 may constitute a lottery ticket, which the customer may put into a collecting box after he/she filled it out, while he/she keeps the coupon 32 as a certifying receipt. The tear between coupons 32 and 34 is of a unique nature, and can authentically certify that the first and second coupons 32 and 34 pertain to each other. This way, no other security marks are needed. Furthermore, counterfeiting would be made even more difficult if the paper strip the printing unit 30 prints on is provided with a complex pattern on its back. The tearing of a complex pattern can securely prove that the coupons 32 and 34 pertain to each other.

FIG. 4 shows a version of the arrangement according to the invention suitable for performing both a primary and a secondary draw. The arrangement comprises an input unit 100, which has an input suitable for inputting the stake of the draw, the type of the game chosen (if there are more than one available), and in certain cases other parameters of the game allowed by the game rules. The input unit 100 has further inputs for inputting data suitable for the identification of the wager, summarizingly called identifiers. Such identifiers may be e.g. the time, place of the wager, and if the person wishing to participate in the draw, hereinafter called the wagerer, wishes so, the data identifying the wagerer and if necessary other data, e.g. the identifier of the person accepting the wager. The input unit, 100 is connected to a control unit 200 suitable for choosing a route. The control unit 200 determines the further route of the data relating to the wager based on the data input by the wagerer. In case of a draw executed by an instant primary draw it is sufficient to forward the data to a drawing centre 400, which performs the draw immediately, and meeting the functions of the drawing unit of the previous solution, but which may be configured to carry out also more complex tasks as well and which drawing centre 400 comprises an odds creating unit 430, a drawing unit 440 connected to said odds creating unit 430 and a game-rule interpreting unit 450 specifying for the odds creating unit 430 the algorithm for creating the winning odds and the parameters of the algorithm and defining for the drawing unit 440 the way of effecting the draw, wherein said game-rule interpreting unit 450 is connected to said control unit 200. The drawing unit 440 immediately performs the draw on the basis of the data received from the odds creating unit 430 and commands received from the game-rule interpreting unit 450, and forwards the result of the draw to the prize display unit 500 connected to its output. The prize displaying unit 500 is preferably located in the vicinity of the input unit 100, and so it displays immediately, or at least within a short time to the wagerer if he/she has won, and if yes, what is the prize won.

If a draw performed later is wanted, or the wagerer chooses such a possibility as allowed by the game rules, the control unit 200 forwards the data relating to the wager to a game database 600. Consequently, in such case the game database 600 includes data relating to the wager, and preferably the game rules applying at the time of the wager is included also here. In this case the draw may be performed in a later point in time (daily, weekly, yearly, etc.), and then all the wagers played within this period participate in the draw. At the time of the draw, the router unit forwards the data of the wagers from the game database 600 to the odds creating unit 430 of the drawing centre 400, and the game-rule interpreting unit 450 reads the game rules applying to a given wager at the time of the wager from the game database 600, and having interpreted these rules forwards them to the odds creating unit 430, e.g. in the form of algorithm parameters. The drawing unit 400 arranges wagers of identical type or wagers to be drawn in the same draw to an appropriate cluster, for which activity it can use the commands received from the game-rule interpreting unit 450, if necessary. After arranging of wagers the drawing unit 440 performs the draw and forwards the result of the draw to the prize displaying unit 500. The prize displaying unit gives the value of the prize along with the data relating to the wager and the identifiers e.g. in a printed form. According to another possibility, the result of the draw may be published on the Internet or in other media.

If the wagerer provides his/her data at the time of the wager, a notification may be sent to him/her based on these data. The control unit 200 preferably forwards the wagerer's data to the customer database 700. The prize displaying unit 500 can read the wagerer's identifiers from the customer database 700, and based on this, a personalized notification can be sent to the wagerer.

Numerous data may be stored in the customer database 700 that are independent of the parameters and the execution of the wager, even so that are to be handled independently of it. For the sake of impartiality the data relating to the identity of the wagerer, the habits of the wagerer, e.g. the number or the value of his/her wagers, or his/her purchasing habits are to be neglected. Commercial aspects may justify that certain wagerers be favoured depending on one of the previous aspects, or excluded from the draw (in case of previous fraud), or their winning odds are reduced (within a period following the payment of a previous prize of greater value, and within a period defineable in the game rules). For this purpose, the customer database 700 is connected to a customer serving unit 800, which completes this function e.g. by modifying the wagerer's stake. For example if the wagerer wagers ten times, then the customer serving unit 800 modifies his/her stake, the type or any other parameter of the game chosen in a way advantageous to the wagerer. In the following, his/her winning odds or the amount of winnable prize is increased, but the draw itself is executed independently of the wagerer's person in the following. In a reverse case, for example in case of a wager within six months after winning a prize over one million Hungarian forints (HUF), the data of the stake played by the wagerer may be modified to his/her disadvantage. The law may prohibit such an intervention, of course.

The arrangement of FIG. 4 can be expediently adjusted to the normal commercial activity of a commercial unit. For this purpose, according to FIG. 5, the cash registers 110 of the commercial unit may be made suitable for the input of data instead of the input unit 100. In such cases, the cashier inputs the data into the system on the basis of the data defined by the wagerer, similarly to a betting shop (horse race, lottery shop), which may be carried out in several ways. According to one of such possibilities the cash register itself may be made suitable for the direct input of the data, in another case the wagerer can choose a ticket (possibly corresponding several types of game, configured with different parameters) from a shelf before the cash register, and the cashier simply handles it as another item of goods. According to another possibility the wagerer may mark the parameters he/she wishes to play on the ticket (e.g. value of the stake, winning odds, etc.). Marking can be carried out by e.g. tearing or breaking the ticket at a given area (see FIG. 8).

According to another solution a printing unit 150 may be placed at the cashier's desk 110, which printing unit 150 may print the parameters of the game wanted to be played. The parameters of the wager may be input by the cashier or the wagerer himself/herself. For the purpose of the wagerer's data input, to the printing unit 150 an input unit 160 is connected, which is connected also to a display 170 at the same time, which displays the parameters of the wager to the wagerer before printing. After the input of data, the printing unit 150 prints a ticket provided with the appropriate data, and at the same time provides it with a code, e.g. bar code, which is used for the identification of individual goods (and their prices) anyway. Then the cashier can handle this printed ticket in the same way as other goods, and inputs the data into the cash register 130 placed at the cashier's desk 110 by means of e.g. a bar code reader 120.

In certain commercial units different customer cards are in use, by which customers can be identified. If wanted, the data of the wagerer as a customer can be input into the system along with the data of the wager by means of such a card handling unit 140. The card handling unit 140 may be suitable for reading chip cards, magnetic stripe cards, or other cards, data carriers, and if it is possible, the data relating to the wager may be written on this card.

At the cashier's desk 110 furthermore a prize displaying unit 510 may be placed, which lets the customer as wagerer know the result of the draw.

In case of greater commercial units, of course the cashier's desk 110 is connected into a local cashier network 10, which has a local server serving the individual cashier's desks 110 operating also as a control unit 210. The same control unit 210 serves the local drawing unit 410 of the commercial unit, which comprises an odds creating unit 430, a game database 460, and a drawing unit 440. The game database 460 is preferably integrated with a database 610, and so the control unit 210 can handle them together. The output of the drawing unit 440 outputting the result of the draw is connected back to the prize displaying unit 510 placed at the cashier's desk 110, and at the same time to a central displaying unit 520 centrally displaying the prizes through the control unit 210 carrying out also the functions of the local server. Furthermore, the local cashier network 10 comprises a customer database connected to the control unit 210 and to a price and stock database 820. These units of the local cashier network 10 are together suitable to centrally carry out all tasks of the arrangement shown in FIG. 4 by the use of several cashier's desks 110. The prize displaying unit may indicate by sound, by image displayed on an appropriately structured graphic display 170 (e.g. image of a whirling roulette wheel) during the draw to the wagerer that the drawing of his wager, his stake played is in progress.

If it is useful or possible to interconnect the local cashier networks 10 of several commercial units, then the local cashier network 10 comprises a transmission unit 12, which is connected to the control unit 210 operating as a local server. Several local cashier networks 10 may be connected to a central server 20 by means of their own transmission units 12, to which central server 20 an additional drawing centre 480 is connected. Theoretically also this drawing centre 480 may be suitable for handling and drawing the wagers played at all cashiers desks 110 of all local cashier networks 10, however, because of uncertainties, possible errors and time delays, immediate draws, and draws within a short time (while the wagerer is at the cashier's desk 110) are rather to be performed by the drawing centre 410 of the local cashier network 10. The central drawing centre 480 may be expediently used for performing draws in a later point in time, e.g. draws performed periodically, or secondary draws.

In case of both arrangements shown in FIGS. 4 and 5 such drawing of lots may be realized where the customer paying for his/her other purchases as a wagerer plays a stake by which he/she rounds the amount to be paid for the goods to a round figure, and thus spares both himself/herself and the cashier from handling money of small denominations. For this purpose, a rounding unit 180 is connected to control units 200 and 210 that rounds up the amount to be paid for the goods to a round figure determined by the customer as a wagerer. The extent of rounding is input by the wagerer or the cashier on the input unit 100 in case of FIG. 4. In case of FIG. 5, a separate input device 160 is made available to the customer for this purpose, which together with the display 170 placed at the cashier's desk 110 makes it possible for the customer to carry out the rounding up as wanted. Therefore in this case the stake played by the wagerer is not a round amount, but a number completing the amount to be paid to a round figure.

The arrangement according to the invention is suitable not only for participation in drawing of lots against paying an appropriate fee, but for other executing draws used generally in commerce for increasing or other kind of influencing the commercial turnover. In this case the value of the stake, the type and parameter of the game depends on the amount of purchase, or the purchase of certain goods or groups of goods, the number of purchased articles according to some kind of prescribed algorithm, e.g. linearly, progressively, degressively. In such case the cashier, the bar code reader 120, or the cash register forwards the relevant information to the input unit 100 on the basis of e.g. the amount of purchase, the number of purchases, etc., or based on the data included in the price and stock database, in certain cases in the customer database.

FIG. 6 is a flow-chart showing the operation of the arrangement of FIG. 5. The schedule below includes the description of the flow-chart, the flow-chart may not be interpreted without it. Numbers represent order; letters after the number represent the routes of branches in progress.

The process starts when the Customer has arrived at the cashier's desk with the shopping basket and the chosen products.

| No. | Description of the process steps | Unit performing the step |
|---|---|---|
| 1000 | The cashier enters all products to the cash register | Cash register |
| 1001 | The cash register stores the input goods, adds up and | Cash register, display, |
| | displays their price, and forwards it also to the rounding | rounding unit |
| | unit at the same time. | |
| 1002 | The rounding unit examines whether the condition | Rounding unit |
| | worth a bonus point has been fulfilled. | |
| 1003 | The rounding unit (possibly by the cashier's | Rounding unit |
| | assistance) offers the drawing of lots to the | |
| | customer, who decides if he/she wants to play. | |
| 1004a | If the customer does not wish to play, the | Cash register |
| | cashier bills the sum of the goods in the | |
| | basket to the customer. | |
| 1005a | The customer pays, receives the change. End of | Cash register |
| 1004b | If the customer wants to play, he/she decides | No machine unit |
| | which game to participate in (e.g. basket prize, or | interplays, only the |
| | only jackpot - we shall return to the latter one | customer tells the cashier |
| | later on) | his/her decision. |
| 1005b | Customer performs the activity constituting the extent | Rounding unit |
| | of rounding (and/or also which game he/she wishes to | |
| | play in) on the rounding unit, and thus determines the | |
| | measure of rounding, and so the basis of the prize in | |
| | forints along with taking possible bonus point into | |
| | consideration. The rounding unit forwards this | |
| | information to the bar code printer. | |
| 1006 | (Continuation of 1005b!) printing bar code of the | Printer |
| | extent of rounding (+bonus point) | |
| 1007 | Reading the bar code into the cash | Bar code reader, cash |
| | register by means of a bar code reader. | register |
| 1008 | The cash register adds the data read by the bar | Cash register |
| | code reader to the sum of the purchased goods, the | |
| | customer pays the total sum rounded this way. | |
| 1009 | Rounding unit forwards the necessary data (value of | Rounding unit, local |
| | purchase, amount of rounding, quantity of bonus points, | drawing centre |
| | etc.) to the local drawing centre, where they are stored | |
| | and processed, and the immediate draw is performed. | |
| | Local drawing centre forwards the result to the rounding | |
| | unit and/or the cash register. | |
| 1010a | If the local drawing centre sends a “no prize” | printer, cash register |
| | message and the Customer does not have a | |
| | customer card, printer or cash register prints the text | |
| | message sent about the result of the draw, which | |
| | customer receives. - End of process! | |
| 1010b | If the local drawing centre sends a “win” | Rounding unit, cash register |
| | message, the printer or the cash register | |
| | prints it out, and the Customer becomes | |
| | entitled to the payment of the basket | |
| | prize. | |
| 1011b | Customer turns in his/her valid prize at the spot | No unit of the |
| | (either at the cashier's desk or a designated place. - | arrangements has any |
| | End of process! | function in this step |
| 1010c | If the local drawing centre sends a “win” message | Rounding unit/cash |
| | and the Customer has a customer card, printer or cash | register |
| | register prints the text message sent about the result of | |
| | the draw, which customer receives. | |
| 1011c | Customer identifies himself/herself with his/her | Card handling unit, |
| | customer card by his or the cashier's placing his/her | control unit, customer |
| | customer card into the card reader for such purpose, | database |
| | which sends the customer's unique identification to the | |
| | control unit. which identifies the customer based on the | |
| 1012 | (continuation of 1011c!) The control unit | Control unit, customer |
| | credits the customer with the points won. | database |
| 1013 | The control unit forwards the points credited and/or | Rounding unit, customer |
| | other necessary parameters to the customer database | database, central drawing |
| | from time to time, based on the data of which the | centre |
| | central drawing unit periodically performs the | |
| | jackpot draw. | |
| 1014a | If a certain customer has not won in the jackpot | Customer database, central |
| | draw, for him/her the draw is repeated until once | drawing centre |
| | he/she wins. - End of process! | |
| 1014b | If central drawing centre (KSK/CDC) has made a | Customer database, central |
| | customer a winner, it forwards this information to | drawing centre |
| | the central customer database. which forwards this | |
| 1015 | (Continuation of 1014b!) Central customer | Customer database |
| | database (KUA/CCD) deletes the points | |
| | pertaining to the actual customer. | |
| 1016 | The jackpot is “paid” to the customer. - | Cash register, customer |
| | End of process! | service |

If the customer wishes to participate only in the game for the jackpot, then the process is completed in the following way:

| | | Unit |
|---|---|---|
| | | performing |
| No. | Description of the process steps | the step |
| 1005c | Same as 1005b | Same as 1005b |
| 1006c | Same as 1006b | Same as 1000b |
| 1007c | Same as 1007b | Same as 1007b |
| 1008c | Same as 1008b | Same as 1008b |
| 1009c | By skipping immediate draw jumps directly to | Same as 1011c |
| | “Registering unique identification”, from where | |
| | the process continues as from 1011c. | |

FIG. 7 shows the most fundamental operations of the execution of the draw. The variables of the game rules, the variables, and constants used in the formulas are the following:
e=the wagerer's unique identifier, which is stored by the magnet/chip-card.
v=total amount to be paid, the value of the actually purchased goods
f=factually paid amount, which is a number increased by the amount intended for the draw
m=remainder, the amount intended for the draw
n=number of purchases, this number increases by one with every purchase
z=Previously defined value, increases the odds after a certain number of purchases
y=the previously defined value of purchase, the reaching of which increases the winning odds
sz=points of a purchase of hundred, which are the points of participation in a greater value draw
t=points of a purchase of ten, which are the points of participation in a basket prize draw
k=basket prize odds value, this means the chance for winning in the draw, equals the number of occurrences of his/her name “in the hat”
ny=prize odds value, the number of participations in a draw of greater prize (not a basket prize)
s=random number generated during the draw that selects the winner from the set “k” of numbers.
k=the number assigned to the winning odds defining the number of occurrences of identifier “e” of the customer.

Formulas:

m=f−v

Value “m” is derived by deducting the value of the purchased goods from the total sum of money paid.

If f>y then sz=sz+1 The sum is greater at purchase than the number previously defined by “y”, its odds is increased by 1 in the drawing of lots. This may be any number, which may be different in different draws, types of games and amounts.

If n>z then t=t+1 Winning odds is affected by also the number of purchases.

If the number of purchases reaches the value “z”, it increases the participation rate, which results in increased odds.

If n>z then sz=sz+1 The previous statement is true for this case too.

k=e^{t}: Participation in a basket prize.

ny=e^{sz} Participation in a non basket prize (jackpot, prize of a greater amount)

In the course of the realization of the method according to the invention we proceed as follows:

Let us assume that the value of the purchased goods is HUF 2346, and the customer hands over HUF 3000, from which amount he claims HUF 600 back only. In this case he dedicates HUF 54 on the draw.

In this case f=2400, v=2346, m=54

First it is determined which game the customer shall play in.

Then his/her data (e, f, n, m) are included in the database, where his/her odds are increased according to the formulas. At each further purchase his/her odds increases due to the fact that his/her identification number being included in the cluster or hat to be drawn from several times as defined by the formulas. At the drawing the machine fills up the number sequence “k” with the identifications “e”, from which a random number generator chooses the winner at a defined point of time.

Let us assume that there are customers “A”, “B”, “C”. Customer “A” is included 9 times, customer “B” 6 times, customer “C” 3 times. Value “k” is 60. From this 60 three are 3 assigned to C, 6 to B and 9 to A, and 42 remaining with no customers connected to them. The odds of A is 15%, of B is 10%, of C is 5%.

The drawing of lots is based on the traditional purchasing process, during which the customer goes to the cashier's desk with the chosen products, where the cashier enters the goods into the cash register 130 by a bar code or in another way, which cash register registers the purchased products and also calculates the amount to be paid, then the customer pays, sometimes the exact amount shown by the cash register, either in cash or by card, and sometimes an amount greater than the shown amount in cash, from which the cashiers gives back the change. It often occurs that the customer leaves the change to the cashier and by the payment of money and/or the possible return of change the purchasing process ends, and the cash register 130 bills the purchase with a receipt. In case of the arrangement and method according to the invention, the process is augmented as follows:

The customer goes to the cashier's desk 130 with the chosen products, where the cashier enters the goods into the cash register in the traditional way, which cash register registers the purchased products and also calculates the amount to be paid (traditional purchasing so far), then the cash register 130 forwards the value of the purchased goods to a connected unit, a rounding unit 180. The rounding unit displays the amount to the customer, who decides whether to pay a round amount or asks for the full return of change. In the latter case the customer does not wish to play and the process of purchasing continues in the traditional way. In the other case, he/she does not claim the odd money back or claims only a part of it, but obtains odds to win as compensation. This can happen also in case of paying by a bank credit card, since the cash register 130 has not confirmed the purchase yet, and it also can be realized that the cashier enters not a number intended for rounding but an amount defined by the customer into the cash register 130, for which the customer obtains odds chance to win. In this case the customer has indicated his/her intention to participate in the draw. The drawing of lots may be of several types: one aiming to win back the purchase price of the products at the cashier's desk chosen in the given situation (referred to as basket prize), or may be a draw aiming to win a jackpot prize (e.g. a car, a trip, etc.) as well (these two may be combined together, e.g. if the customer has not won a basket prize, then his/her purchase and rounding is registered in a central customer database after an appropriate identification. Based on all these parameters and the published game rules winning odds are created for him/her to win the jackpot. This version shall be taken as basis in the following). The rounding unit 180, which is connected to also a printer 150, prints a “lottery ticket” of the amount defined by the customer, whereon the important parameters may be indicated, and/or it is worth to provide it with a bar code, based on which the stake played can be entered as a product into the cash register 130 with a bar code reader. Then the cash register confirms the payment to the rounding unit. If the drawing of lots is aimed at a basket prize, the control unit 210 forwards the winning odds of the basket prize in the given transaction to a local drawing unit 410 (placed in the store, and connected to the rounding unit), which draws for the customer if he/she has won by means of a random number generator depending on the value of purchase, the measure of rounding, and the winning probability parameter (referred to as X in the formula schedule) adjusted according to the game rules, and according to defined weightings. The local drawing centre 410 forwards the result (win/no prize) to the prize displaying unit 510, which either prints the result by means of the printer 150 or forwards it to the cash register to print it along with the value of the purchase excluding the “lottery ticket”, and the customer presents the printed receipt at an appropriate counter (e.g. cashier's desk, or information counter) if he/she is entitled to have the purchase price refunded.

If the result of the draw is “no prize”, then in case of a customer who has a customer card (which identifies him/her with a unique identifier at purchasing) the winning odds generated according to parameters defined in the game rules shall be added to the database record identified by the customer card by means of a card reader, let us call this customer credit points (it is useful to define this by direct proportionality with the basket prize, and/or to award purchases with loyalty points on the basis of predetermined conditions such as number of shoppings, amounts of purchases, and combinations thereof, etc.) and thereby the, credit points can be further increased resulting in increased odds for winning a jackpot or superprize.) The unique identification of the buyer as a customer is forwarded from the card handling unit 140 used for reading the customer card to the control unit 210 that compares the data with the records of the customer database 810, and periodically credits the relevant record of the customer database 810 with the points for the relevant purchase (detailed as wanted: e.g. rounded amount, loyalty points separately) following a successful identification. In addition to registering the customer's number of points is definitely worth it to register the extent of rounding (for financial and gambling regulation reasons), information relating to the purchased goods (for market research reasons), etc. The central drawing centre periodically (e.g. monthly, quarterly, etc.) draws jackpots or superprizes on the basis of the data of the central customer database 810 among the customers. If a customer has won a superprize, his points are reduced to zero and can start collecting points again proportionately to the amounts of the roundings and/or purchases. For the purpose of increasing the winning odds of new joiners, thus keeping up purchasing and playing spirits it is useful to periodically (e.g. at the end of each year—at Christmas) exchange a part (e.g. the half) of the existing customers' points to smaller or greater presents (e.g. 100 points—small box of bonbons, 500 points—large box of bonbons, 5000 points—champagne, etc.).

The whole drawing of lots may be worth to be integrated with so called bonus points, which may be added to the relevant purchase in case of the fulfillment of certain conditions, and proportionately to their extent, e.g. a “bonus rounding” that increases the winning odds both for the basket prize and other prizes. These conditions may be: the purchase of certain products, the purchase of a certain manufacturer, the joint purchase of certain products, belonging to a specified socio-demographic group, etc. It is important that although bonus points operate similarly to roundings, they have to be registered separately because of different legal regulations (e.g. it does not increase the prize base, because it was not purchased by the customer, but given by the store).

FIG. 8 shows a device 122 that is for facilitating data input and can be handled as an item of goods in the commercial unit. Said device 122 is a typographically printed card, which is provided with included data and identifiers in the form of bar codes 124 and 125. Device 122 is provided also with a inscription 123 readable by customers, which inscription 123 jointly with e.g. the colour of the device 122 defines the type of the game in which a right to participate may be obtained by the relevant device 122. The device 122 is formed in a way disseverable (tearable, breakable) along severing lines 126. The bar code 124 spreads along the whole length of the device 122, and this bar code is shortened when the device 122 is severed along the severing lines 126. The main ticket provided with the inscription 123 remains at the wagerer or customer, and the severed other part is kept by the cashier at the cashier's desk 110. The bar codes 125 on the withdrawn part also make possible the posterior identification of the wager played. Accordingly, the device 122 carries the value of the stake played and the type of game chosen. The customer can choose a game where the value of the stake is determined by rounding. In such case the customer can decide by severing along the severing lines 126 whether he/she wants a rounding up to ten, hundred, even hundred, five hundred or thousand. Game rules can be written on the back of the device 122, the acceptance of these rules is confirmed by breaking the device 122 and/or its handling to the cashier.

It is particularly important to note that the individual units, their functions may be realized by a single or several processors and the serving units traditionally pertaining to it, or them which represents only a realization of the solution according to the invention structured and distributed differently in time and space.

1. Apparatus for decreasing the circulation of money of small denominations and coins, especially for use at retail sales points characterized by an input unit (400) adapted for inputting the amount to be paid, which input unit (400) is connected to a central unit (100), and further comprising an input unit (500, 900) for defining a rounded amount to be paid and connected to said central unit (100) for controlling a rounding unit (110\ wherein a display unit (200) showing a rounded payable sum defined by said rounding unit (110) and a printing unit (300) is connected to said central unit (100).

2. The apparatus claimed in claim 1 characterized by a drawing unit (600) operating on the basis of an algorithm defining winning odds and connected to said central unit (100).

3. The apparatus claimed in claim 1 characterized by comprising a separate first input unit (400) for inputting a sum to be paid and a displaying unit (210) as well as a separate customers' input unit (500) for inputting an amount to be paid derived by rounding up a payable sum or the extent of rounding, and a displaying unit (220).

4. The apparatus claimed in claim 1 characterized in that said printing unit (300) is adapted for printing a ticket (302) indicating the extent of rounding and symbolizing an item of goods such as a purchasing ticket.

5. The apparatus claimed in claim 1 characterized in that said printing unit (300) is adapted for printing a first coupon (302) and a second coupon (304) separated from each other by a tear-line such as perforation line.

6. The apparatus claimed in claim 1 characterized in that the central unit (100) is connected to a local and/or central prize-indicating unit (800).

7. The apparatus claimed in claim 1 characterized in that said central unit (100) is connected to a centralized data network.

8. The apparatus claimed in claim 2 characterized in that for influencing winning odds said drawing unit (600) is connected to a timing unit (120) included optionally in said central unit (100).

9. Arrangement for drawing lots and comprising an input unit for entering data of participation in said drawing, and a drawing centre including a database of game rules, a game rule interpreting unit, an odds creating unit and a drawing unit connected to a prize indicating unit characterized in that said input unit is connected to said drawing centre (400, 410) via a control unit (200), furthermore a game database (600) is connected to said control unit (200).

10. The arrangement claimed in claim 9 characterized in that a customer database (810) is connected to said control unit (200, 210), said customer database (810) is in connection with said prize indicating unit (500).

11. The arrangement claimed in claim 10 characterized in that a customer handling unit (800) is connected to said customer database (810), said customer handling unit (800) is in connection with said input unit (100, 160) for modifying data of participation in said draw.

12. The arrangement claimed in claim 9 characterized in that said input unit (100) is formed on a cash register (130) and a rounding unit (180) is connected to said control unit (200, 210) for rounding up the countervalue of items of goods entered into said cash register (130) and defining the amount of rounding up as a stake.

13. The arrangement as claimed in claim 9 characterized in that said input unit (160) is arranged at a cashier's desk (110) and provided with a display (170) and a prize indicating unit (510), said cash register (130) is arranged at said cashier's desk (110), and is associated with means for reading identification data of items of goods, such us barcode-reader (120), wherein a printing unit (150) adapted for printing entered data onto a data carrying medium in a form readable both by eye and by said means for reading identification data of items of goods is associated with said input unit (160).

14. The arrangement as claimed in claim 9 characterized in that said control unit (210) is formed as a server for serving several cashier's desks (110), and is connected to a local cashier network (10) along with said cashier's desks (110).

15. The arrangement as claimed in claim 12 characterized in that said local cashier network (10) comprises a transmission unit (12) connected to said control unit (210), and the local cashier network (10) is in connection with a central server (20) via the transmission unit (12), and a plurality of local cashier networks (10) are connected to said central server (20).

16. The arrangement as claimed in claim 15 characterized in that a drawing centre (480) is connected to said central server (20).

17. The arrangement as claimed in claim 14 characterized in that a central indicating unit (520) announcing the prize drawn on the basis of the wagers played at several cashier's desks (110) is connected to said control unit (210).

18. Method for drawing lots of wagerers participating in a draw of lots, comprising the steps of accepting the stakes; giving receipts of said stakes if necessary; and performing a draw on the basis of said stakes and according to prescribed game rules; and in case of winning handing out the prize won to the relevant wagerer characterized in that said stakes are accepted at a cashier's desk (110) of a commercial unit in the course of purchase, and stakes played are booked by using a cash register (130) and a certificate issued by said cash register (130) is handed out as a receipt.

19. The method as claimed in claim 18 characterized by offering a stake completing the amount to be paid in the course of purchase to a round sum, and the stake thus approved by the customer is accepted by entering relevant data into said input unit (100, 160).
